(19) United States
(12) Patent Application Publication
(10) Pub. No.: US 2013/0082669 A1
(43) Pub. Date: Apr. 4, 2013

(54) SCALABLE MULTIPHASE-REGULATOR POWER-INTEGRATED CIRCUIT SYSTEM AND METHOD FOR PROVIDING SCALABLE POWER TO THE SAME

(71) Applicant: Peng Xu, San Jose, CA (US)

(72) Inventor: Peng Xu, San Jose, CA (US)

(73) Assignee: MONOLITHIC POWER SYSTEMS, INC., San Jose, CA (US)

(21) Appl. No.: 13/249,144

(22) Filed: Sep. 29, 2011

(51) Int. Cl. G05F 1/10

(52) U.S. Cl. 323/271

(57) ABSTRACT

In one embodiment, a modular master chip includes an output module, a phase control module in communication with the output module, the phase control module including a master chip switch, wherein the phase control module is adapted for regulating the master chip switch at one or more interleaved clock speeds with one or more phase shifts, and a control module in communication with the output module and the phase control module, the control module being adapted for monitoring an amount of current drawn by a current load, determining one or more interleaved clock speeds, sending the one or more interleaved clock speeds, and regulating a scalable amount of current supplied to the current load by adjusting a number of output modules contributing to the scalable amount of current supplied to the current load. More methods and systems are described according to other embodiments.

### FIELD OF THE INVENTION

The present invention relates to power-integrated circuits, and more particularly to power management of microprocessors.

### BACKGROUND

In order to accomplish the enormous computational tasks demanded by the modern information society, application-specific integrated circuits (ASICs), microprocessors such as graphics processing units (GPUs), central processing units (CPUs), etc., require high amounts of current, typically on the order of 10² amperes, to be provided at relatively low voltages, typically less than about one volt. This requires highly specialized power-integrated circuit systems that are capable of providing the requisite current at concurrently low potentials to be used for power delivery systems.

To analyze ever larger and more complex datasets, increasing computational power is required to power the processors performing those calculations. In order to address this strong need and provide additional computing resources, microprocessors with geometrically increasing transistor density have been produced, and multiple microprocessor cores have become commonplace in many computers.

Hyperthreading technology has allowed the utilization of multiple processing cores efficiently in computational tasks, but also requires additional management of transistor phases in order to avoid signal interference. Additionally, as computational resource capacity continues its exponential growth, so too does computer node power consumption. These rapid rates of growth cultivate an industry where power requirements across generations of microprocessors cannot be accommodated by similar circuit boards because of incompatible phase number and current requirements. As a result, nearly every generation of new microprocessor requires accompanying new circuitry to meet power requirements, increasing the cost and the time needed for development and deployment of the new microprocessors.

It is thus desirable to provide a power-integrated circuit system capable of supplying power to a flexible range of microprocessors that is capable of customizable adjustment to provide scalable power to a diverse range of present and future generations of microprocessors.

### SUMMARY

In one embodiment, a circuit includes a modular master chip adapted for monitoring an amount of current drawn by a current load and regulating a scalable amount of current supplied to the current load by adjusting a number of slave chips contributing to the scalable amount of current supplied to the current load.

In another embodiment, a method includes monitoring an amount of current drawn by a current load, adjusting a maximum scalable current to be supplied to the current load by modifying a number of active slave chips coupled to a modular aster chip, adjusting one or more phase shifts at one or more interleaved clock speeds between each of the active slave chips and the master chip, driving an output module of the modular master chip and an output stage of each of the active slave chips, combining an output current from the output module of the modular master chip and an output current from each of the output stages of the active slave chips to produce a scalable current to be supplied to the current load, and providing the scalable current to the current load, wherein each of the one or more slave chips is coupled in parallel to the modular master chip, and the modular master chip is capable of automatically regulating the modular master chip and each of the active slave chips at one or more interleaved clock speeds with one or more phase shifts to provide the scalable current to the current load.

In yet another embodiment, a circuit includes a modular master chip, the modular master chip including an output module, a phase control module in communication with the output module, the phase control module including a master chip switch, wherein the phase control module is adapted for regulating the master chip switch at one or more interleaved clock speeds with one or more phase shifts, and a control module in communication with the output module and the phase control module, the control module being adapted for monitoring an amount of current drawn by a current load, determining one or more interleaved clock speeds, sending the one or more interleaved clock speeds, and regulating a scalable amount of current supplied to the current load by adjusting a number of output modules contributing to the scalable amount of current supplied to the current load.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a schematic layout of a circuit for managing power in a scalable power-integrated circuit system, according to one embodiment.

FIG. 2 shows a block-diagram of a circuit for managing power in a scalable power-integrated circuit system, according to one embodiment.

FIG. 3 is a flowchart of a method for providing scalable power to a current load, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In one general embodiment, a circuit includes a modular master chip adapted for monitoring an amount of current drawn by a current load and regulating a scalable amount of current supplied to the current load by adjusting a number of slave chips contributing to the scalable amount of current supplied to the current load.

In another general embodiment, a method includes monitoring an amount of current drawn by a current load, adjusting a maximum scalable current to be supplied to the current load by modifying a number of active slave chips coupled to a modular master chip, adjusting one or more phase shifts at one or more interleaved clock speeds between each of the active slave chips and the master chip, driving an output module of the modular master chip and an output stage of each of the active slave chips, combining an output current from the output module of the modular master chip and an output current from each of the output stages of the active slave chips to produce a scalable current to be supplied to the current load, and providing the scalable current to the current load, wherein each of the one or more slave chips is coupled in parallel to the modular master chip, and the modular master chip is capable of automatically regulating the modular master chip and each of the active slave chips at one or more interleaved clock speeds with one or more phase shifts to provide the scalable current to the current load.

In yet another general embodiment, a circuit includes a modular master chip, the modular master chip including an output module, a phase control module in communication with the output module, the phase control module including a master chip switch, wherein the phase control module is adapted for regulating the master chip switch at one or more interleaved clock speeds with one or more phase shifts, and a control module in communication with the output module and the phase control module, the control module being adapted for monitoring an amount of current drawn by a current load, determining one or more interleaved clock speeds, sending the one or more interleaved clock speeds, and regulating a scalable amount of current supplied to the current load by adjusting a number of output modules contributing to the scalable amount of current supplied to the current load.

According to one embodiment, a scalable multiphase-regulator power-integrated circuit includes a modular master chip including an output module, a phase control module in communication with the output module, the phase control module having a master chip switch, wherein the phase control module is adapted for (e.g., configured to) regulate the master chip switch at one or more interleaved clock speeds with one or more phase shifts, and a control module in communication with the output module and the phase control module, the control circuit module being adapted for monitoring an amount of current drawn by a current load, determining one or more interleaved clock speeds, sending the one or more interleaved clock speeds, and regulating a scalable amount of current supplied to the current load by adjusting a number of output modules contributing to the scalable amount of current supplied to the current load, wherein the control module is removably coupled to the phase control module.

In another embodiment, the scalable multiphase-regulator power-integrated circuit further includes one or more slave chips, wherein each slave chip includes an output stage and a phase control stage in communication with the output stage. The phase control stage has a slave chip switch, wherein the phase control stage is adapted for regulating the slave chip switch at one or more interleaved clock speeds with one or more phase shifts, and wherein each of the one or more slave chips is coupled in parallel with the modular master chip. The modular master chip is adapted for automatically regulating the modular master chip switch and each slave chip switch of the one or more slave chips at one or more interleaved clock speeds with one or more phase shifts to supply the scalable amount of current to the current load.

In yet another embodiment, the modular master chip may also include a control circuit amplifier. Any control circuit amplifier as would be known to one of skill in the art may be used.

According to one embodiment, the system may incorporate an oscillator in communication with the phase control module and the phase control stage of each of the one or more slave chips, and the control circuit amplifier may match the oscillator for generating an oscillating signal.

In addition, in another embodiment, the circuit may include a control circuit amplifier that is adapted for sending a signal to distribute current contributions from each of the one or more slave chips and the modular master chip to contribute to the scalable amount of current supplied to the current load.

The phase control module and each phase control stage of the one or more slave chips may also include a real-time phase detector-splitter adapted for adjusting the one or more phase shifts at the one or more interleaved clock speeds in response to the signal from the control circuit amplifier, in one approach.

In another approach, the master switch and each slave switch of the one or more slave chips may utilize a phase-width modulator adapted for operating as a switch at one or more interleaved clock speeds with one or more phase shifts in response to the signal from the control circuit amplifier.

According to one approach, the circuit may be adapted for supplying a current load with a relatively high current at correspondingly low voltages, for example the circuit may provide the current load with an amount of current exceeding about 100 amperes at a corresponding potential of less than about 1 volt, greater than about 75 amps at a voltage of less than about 0.9 volt, greater than about 120 amps at less than about 1.2 volts, etc.

In one embodiment, the output module may include a driver, a voltage supply, two transistors, and a ground. However, any other output arrangement as would be understood by one of ordinary skill in the art upon reading the present descriptions may be used in various embodiments.

In another approach, the one or more phase shifts may be equally distributed across a band spectrum. In alternative approaches, phase shifts may be unequally distributed across a band spectrum. By band spectrum, what is meant is all of the possible phases that may be achieved in a power delivery system. For example, phase shifts may be equally distributed at 0°, 90°, 180°, and 270°. In another example, phase shifts may be equally distributed at 0°, 60°, 120°, 180°, 240°, and 300°. In yet another example, phase shifts may be unequally distributed, such as at 0°, 60°, 240°, and 300°, or in any other unequal distribution as known in the art.

Furthermore, in one embodiment, a loop may couple the phase control module and each phase control stage in a closed circuit. In this way, the system may be better adapted for regulating the plurality of chips integrated into the circuit at interleaved clock speeds with appropriate phase shifts, as would be understood by one of ordinary skill in the art upon reading the present descriptions.

In another approach, the control module and the phase control module may be positioned at opposite sides of the master chip to maximize a useable pin count on the master chip by allowing more space between the modules. Alternatively, the one or more slave chips may be positioned between the control module and the phase control module, with the one or more slave chips being adapted for direct access via removing the control module from the modular master chip.

In some approaches, the current load may be a microprocessor, but is not so limited, as the current load may be any current load as would be understood by one of ordinary skill in the art upon reading the present descriptions, such as a system, device, module, etc.

In order to optimally utilize the described circuit system, according to one approach, a method of providing scalable power to a scalable multiphase-regulator power-integrated circuit may include monitoring an amount of current drawn by a current load, adjusting a maximum scalable current to be supplied to the current load by modifying a number of active slave chips coupled to a modular master chip, adjusting one or more phase shifts at one or more interleaved clock speeds between each of the active slave chips and the master chip, driving an output module of the modular master chip and an output stage of each of the active slave chips, combining an output current from the output module of the modular master chip and an output current from each of the output stages of the active slave chips to produce a scalable current to be supplied to the current load, and providing the scalable current to the current load. Each of the one or more slave chips is coupled in parallel to the modular master chip, and the modular master chip is capable of automatically regulating the modular master chip and each of the active slave chips at one or more interleaved clock speeds with one or more phase shifts to provide the scalable current to the current load.

One additional approach may include coupling one or more additional slave chips to the master modular chip to increase the maximum scalable current, as each slave chip is capable of providing additional current to the current load, and adding more slave chips increasing the maximum possible current (which can then be scaled to a lower current) that can be provided to the current load.

Alternatively, yet another approach may include decoupling one or more slave chips from the modular master chip to decrease the maximum scalable current.

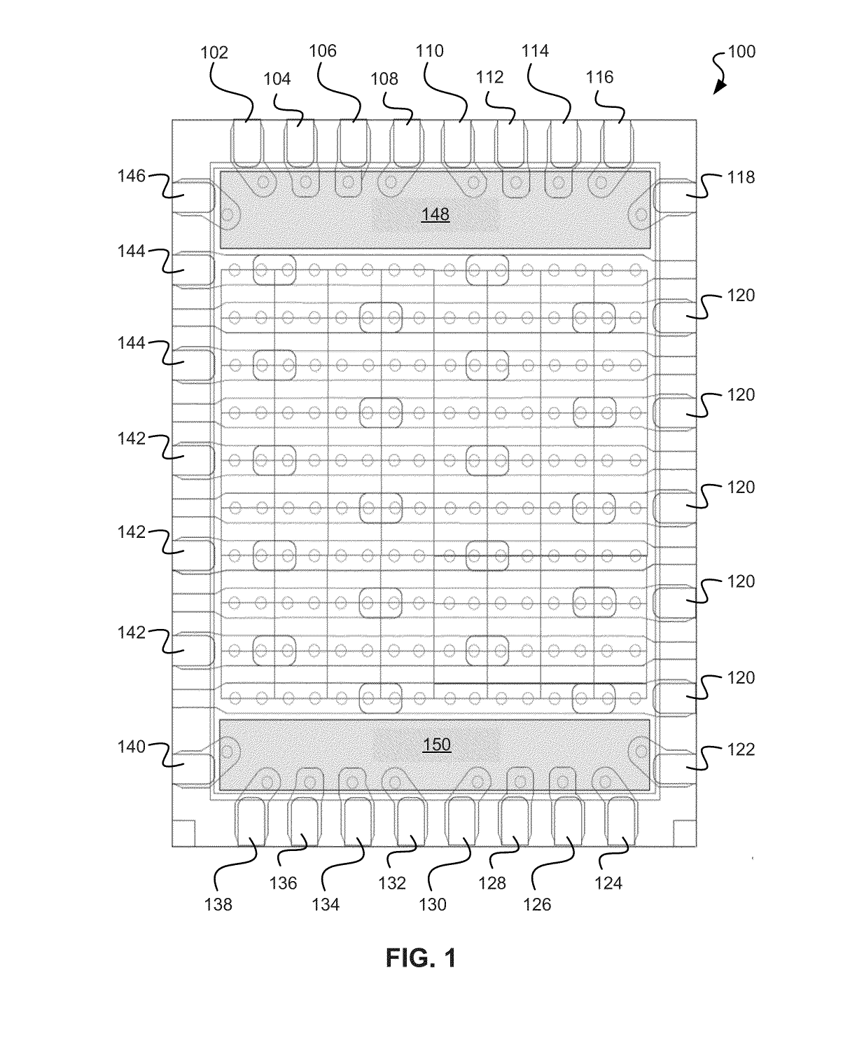

Referring now to the figures, FIG. 1 shows a schematic layout of a scalable power-integrated circuit system 100 layout, according to one embodiment. In the layout depicted, the system includes a main control 148 at one terminus of the system and a phase control 150 at the opposing terminus. By placing the main control 148 and the phase control 150 at opposing termini, it will be appreciated that one may advantageously maximize a useable pin count on the chip.

Furthermore, in one general approach, a plurality of output terminals may be located along the periphery of the chip for conducting signals through the circuit system. The output terminals as shown in FIG. 1 utilize lead frames as conductive routings, but of course, output terminals may utilize other conductive routing equivalents as understood by one having ordinary skill in the art.

Generally, the output terminals may connect one or more elements of the circuit system 100, and according to one embodiment, the system may include several output terminals connected to elements adapted for managing system power. As shown in FIG. 1, FB output terminal 102 connects to a feedback loop of the circuit system 100, and DROOP output terminal 104 connects to a combined output, or droop signal. Furthermore, IOUT output terminal 134 may connect to an output current from the outputs of the circuit system 100.

In addition, VDD output terminal 140 may connect to a system control voltage supply, and IN output terminals 144 may connect to individual voltage supplies for each pair of transistors included in output modules of the circuit system 100.

In another approach, SW output terminals 120 may connect to the middle point of each pair of transistors included in the output modules of the circuit system 100. The SW output terminals 120 may be tied to a system inductor, and may further be tied to a capacitor connected to the BS output terminal 122. BS output terminal 122 serves as a sloping voltage supply boost signal to the chip as needed to supply the power transistors, but it will be appreciated that the system may employ any typical manner of driving an unpacked power transistor as would be understood by one of ordinary skill in the art upon reading the present descriptions.

In yet another embodiment, the circuit system 100 may include several ground leads, notably AGND output terminal 106 may serve as an analog ground, and POND output terminals 142 may serve as digital grounds.

In another embodiment, the circuit system 100 may include several reference signals. As show in FIG. 1, REFIN output terminal 108 connects to a reference voltage IN, REFOUT output terminal 110 connects to a reference voltage OUT, and RFREQ output terminal 112 connects to a reference frequency signal for the same.

Furthermore in alternative approach, IMON and TEMP output terminals, 114 and 116, respectively, may connect to a housekeeping module that monitors the amount of current drawn by the circuit system 100 and the temperature of the circuit system 100, respectively. Furthermore, POK output terminal 118 may connect to another housekeeping monitor signal indicating whether the amount of power provided to the circuit system 100 is within acceptable limits.

With continued reference to FIG. 1, and according to yet another embodiment, TKO and TKI output terminals 124 and 126, are respectively tied to an output and an input of a closed loop connecting real-time phase detectors/splitters that regulate the phase shift and interleaved dock speeds at which the one or more output modules of the circuit system 100 operate.

In another approach, CLK output terminal 128 may be tied to a system clock signal generated by an oscillator in response to the reference frequency to which RFREQ output terminal 112 is connected.

Furthermore, M1 output terminal 130 and M2 output terminal 132 may be connected to logic signals that set an operation mode of the one or more output modules integrated with the circuit system 100. The logic signals may take the form of pulse-width modulators, pulse-frequency modulators, or any other equivalent as would be understood by one of ordinary skill in the art upon reading the present descriptions. In addition, the system may include an EN output terminal 138 connected to the phase control 150 and adapted for enabling and disabling the various output modules connected to the circuit system 100.

Referring again to FIG. 1, in one approach, COW output terminal 146 and ICTL output terminal 136 may be connected to control signals which command the contributions of scalable amounts of power to be provided to the current load from the plurality of chips comprising the circuit system 100.

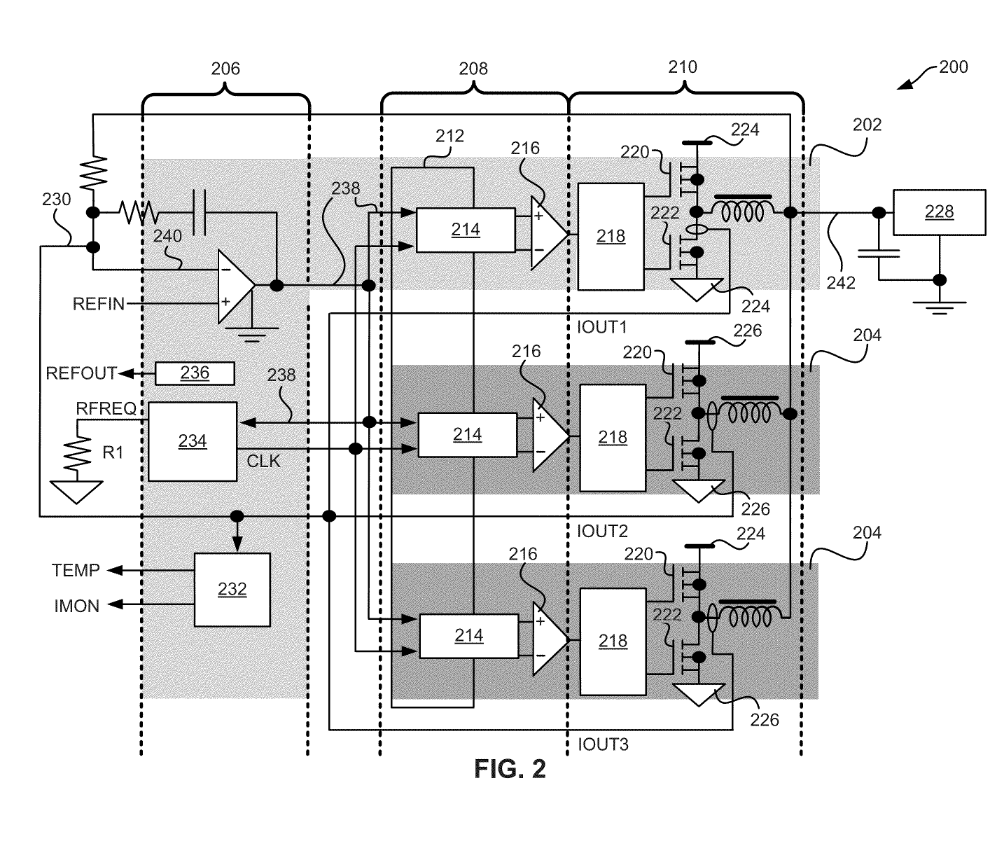

FIG. 2 shows a scalable multiphase-regulator power-integrated circuit 200 for providing scalable power to a current load 228, in accordance with one embodiment. As shown, the circuit 200 includes a master chip 202 and two slave chips 204 connected in parallel, hut other arrangements including at least a master chip and any number of slave chips may alternatively be used, in accordance with various embodiments.

With continued reference to FIG. 2, and according to one embodiment, the modular master chip 202 may comprise three primary functional units: a main control module 206, a phase control module 208, and an output module 210. Similarly, each slave chip 204 may include a phase control stage 208 and an output stage 210.

The main control module 206 may include a monitoring element 232 in direct communication with the combined output of the output module and each output stage, also referred to as a “droop” signal 230, in one approach. In another embodiment, the monitoring element 232 may be adapted for collecting housekeeping data such as a circuit 200 temperature TEMP and amount of current IMON being drawn by the current load 228.

In another approach, main control module 206 may include an amplifier element 238 adapted for generating a signal to command the contributions of scalable amounts of power to the current load 228 from the plurality of chips comprising the circuit 200.

Additionally, one arrangement of the main control module 206 includes a feedback loop 240 for collecting feedback data from the droop signal 230. In yet another embodiment, control stage 206 may also include a reference voltage supply 236 which generates a reference voltage REFOUT.

Furthermore, in one approach, the control stage 206 may include an oscillator 234, possibly attached to a resistor R1, and adapted for generating an oscillating signal CLK in response to a reference frequency RFREQ generated by the resistor R1.

The phase control module, referred to herein as a phase control stage 208 of each chip 202, 204 is adapted to regulate a chip switch 216 at one or more interleaved clock speeds with one or more phase shifts, and may include a real-time phase regulator and splitter 214 adapted for distributing chip contributions at equal phase shifts across a band spectrum.

In one approach, the real-time detectors and splitters 214 of each chip 202, 204, may be in direct communication with one another via a phase control loop 212 which may connect each real-time detector and splitter in a closed circuit.

Additionally, each phase control module or stage 208 may include a switch 216 in communication with the real-time phase detector and splitter 214, and adapted for operation as a gate controlling the contribution of power by the output module or stage 210 of each chip 202, 204, in another approach.

In one preferred embodiment, each switch 216 may comprise a pulse-width modulator, but may alternatively be a pulse-frequency modulator, or any switch capable of operating as a logic gate to control contribution of power to a circuit, as would be understood by one of ordinary skill in the art upon reading the present descriptions.

In another preferred embodiment, as additional slave chips are added or activated to accommodate greater current draws from the current load 228, the phase control stage 208 may automatically adjust interleaved clock speeds and phase shifts for each chip, allowing for seamless integration and highly scalable power output to meet the requirements of a variety of current loads, such as a variety of microprocessor chip generations and microprocessor chip designs.

According to one embodiment, the output stage 210 of each chip may be provided with a first transistor 220 and a second transistor 222. It should be noted that the first transistor 220 and the second transistor 222 may take any form, as would be understood by one of ordinary skill in the art upon reading the present descriptions. For example, the first transistor 220 and/or the second transistor 222 may include a p-type transistor or n-type transistor. Further, in one embodiment, the transistors 220 and 222 may include field-effect transistors (FETs), metal-oxide-semiconductor field-effect transistors (MOSFETs), driver-metal-oxide-semiconductors (DrMOS), etc. Of course, other transistors may be used, as would be understood by one of ordinary skill in the art upon reading the present descriptions.

Referring again to FIG. 2, it should be noted that the circuit 200 as shown includes transistors 220 and 222 which are connected to a driver 218, but may be interconnected in any desired manner as would be understood by one of ordinary skill in the art upon reading the present descriptions. For example, as shown, the first transistor 220 may include an upper transistor coupled to a voltage source 224, and the second transistor 222 may include a lower transistor connected to a digital ground 226. Still yet, the transistors 220 and 222 may have interconnected gates serving as an input and interconnected drains serving as an output. Of course, other configurations are possible.

Furthermore, according to one embodiment, each chip produces a current, IOUT, and individual current outputs are combined into a single output signal 242. As shown in FIG. 2, the output current of the master chip 202 is IOUT1, and is combined with the output currents IOUT2, IOUT3, . . . , from each slave chip 204, forming the combined droop signal 230. The droop signal 230 is directed through the control stage 206 where control module 232 may collect housekeeping data that may include, but is not limited to, system temperature TEMP and the amount of current draw IMON of the current load 228.

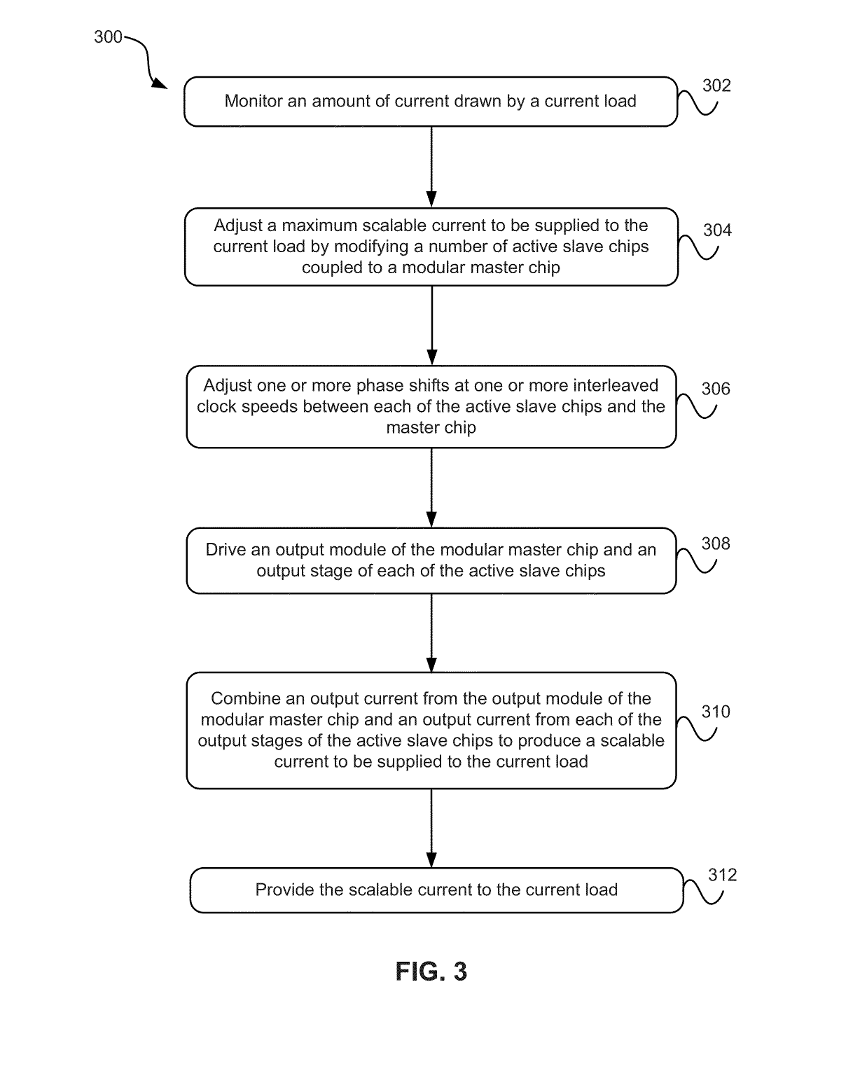

Referring now to FIG. 3, a method 300 is shown for supplying scalable power to a current load, according to one embodiment. The method 300 may be carried out in any desired environment, including those described in FIGS. 1-2, according to various embodiments.

In operation 302, an amount of current drawn by a current load is monitored. Of course, if the amount of current being drawn is already known or is able to be provided, then the monitoring is not required and the current draw is received.

Its operation 304, a maximum scalable current to be supplied to the current load is adjusted by modifying a number of active slave chips coupled to a modular master chip. For example, if the maximum scalable current is 100 amps with a master chip capable of 20 amps and 4 slave chips each capable of 20 amps, then the maximum scalable current may be adjusted to 80 amps by removing one slave chip, or may be increased to 140 amps by adding two additional slave chips. Of course, an infinite number of variations on this technique are possible, as would be understood by one of skill in the art upon reading the present descriptions, according to various embodiments, based on different master and slave chip current outputs, and the number of slave chips, which can vary between zero and a maximum connectable total, which would be limited only by space and layout concerns, but may be less than or equal to 10, greater than 10, greater than 20, etc.

In operation 306, one or more phase shifts at one or more interleaved clock speeds is adjusted between each of the active slave chips and the master chip. In this way, a consistent amount of power may be provided to the current load from each of the contributing chips, e.g., master chip and slave chip(s).

In operation 308, an output module of the modular master chip and an output stage of each of the active slave chips is driven, thereby providing an output current to the current load.

In operation 310, an output current from the output module of the modular master chip and an output current from each of the output stages of the active slave chips is combined to produce a scalable current to be supplied to the current load.

In operation 312, the scalable current is provided to the current load.

Of course, in one embodiment and as described above, each of the one or more slave chips is coupled in parallel to the modular master chip, and the modular master chip is capable of automatically regulating the modular master chip and each of the active slave chips at the one or more interleaved clock speeds with the one or more phase shifts to provide the scalable current to the current load.

In another embodiment, the method 300 may include coupling one or more additional slave chips to the master modular chip to increase the maximum scalable current.

In another embodiment, the method 300 may include decoupling one or more slave chips from the modular master chip to decrease the maximum scalable current.

Of course, any of the other methods described herein to adjust and/or regulate the current provided to the current load may be used in conjunction with method 300, in various embodiments.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A circuit, comprising:
a modular master chip being adapted for:
monitoring an amount of current drawn by a current load; and
regulating a scalable amount of current supplied to the current load by adjusting a number of slave chips contributing to the scalable amount of current supplied to the current load.

2. The circuit as recited in claim 1, wherein the scalable amount of current supplied to the current load is regulated by adjusting an output current from each of the number of slave chips.

3. The circuit as recited in claim 1, wherein the modular master chip comprises:
an output module adapted for outputting a current;
a phase control module in communication with the output module, the phase control module comprising a master chip switch, wherein the phase control module is adapted for regulating the master chip switch at one or more interleaved clock speeds with one or more phase shifts; and
a control module in communication with the output module and the phase control module, wherein the control module is adapted for:
determining the one or more interleaved clock speeds; and
sending the one or more interleaved clock speeds to the master switch and a slave chip switch of each slave chip.

4. The circuit as recited in claim 3, further comprising one or more slave chips, each slave chip being adapted for outputting a current.

5. The circuit as recited in claim 4, wherein each slave chip comprises:
an output stage; and
a phase control stage in communication with the output stage, the phase control stage comprising a slave chip switch, wherein the phase control stage is adapted for regulating the slave chip switch at the one or more interleaved clock speeds with the one or more phase shifts,
wherein each of the one or more slave chips is coupled in parallel with the modular master chip, and
wherein the modular master chip is adapted for automatically regulating the modular master chip switch and each slave chip switch of the one or more slave chips at the one or more interleaved clock speeds with the one or more phase shifts to supply the scalable amount of current to the current load.

6. The circuit as recited in claim 5, wherein the master switch and each slave switch of the number of slave chips comprise a pulse-width modulator adapted for operating as a switch at the one or more interleaved clock speeds with the one or more phase shifts in response to the signal from the control circuit amplifier.

7. The circuit as recited in claim 5, wherein the one or more phase shifts are equally distributed across a band spectrum.

8. The circuit as recited in claim 5, wherein a loop couples the phase control module and each phase control stage in a closed circuit.

9. The circuit as recited in claim 4, wherein the control module and the phase control module are positioned at opposite sides of the master chip to maximize a useable pin count on the master chip.

10. The circuit as recited in claim 9, wherein the number of slave chips are positioned between the control module and the phase control module, and wherein the number of slave chips are adapted for direct access via removal of the control module from the modular master chip.

11. The circuit as recited in claim 1, further comprising a control circuit amplifier and an oscillator, wherein the control circuit amplifier is adapted for producing a signal for distributing current contributions from each of the number of slave chips and the modular master chip, wherein the signal corresponds to an oscillating signal produced by the oscillator.

12. The circuit as recited in claim 11, wherein the control circuit amplifier is adapted for sending the signal to each of the number of slave chips and the modular master chip.

13. The circuit as recited in claim 1, wherein the circuit is adapted for supplying the current load with an amount of current exceeding about 100 amperes at a corresponding potential of less than about 1 volt.

14. The circuit as recited in claim 1, wherein the current load is a microprocessor.

15. A method, comprising:
monitoring an amount of current drawn by a current load;
adjusting a maximum scalable current to be supplied to the current load by modifying a number of active slave chips coupled to a modular master chip;
adjusting one or more phase shifts at one or more interleaved clock speeds between each of the active slave chips and the master chip;
driving an output module of the modular master chip and an output stage of each of the active slave chips;
combining an output current from the output module of the modular master chip and an output current from each of the output stages of the active slave chips to produce a scalable current to be supplied to the current load; and
providing the scalable current to the current load,
wherein each of the one or more slave chips is coupled in parallel to the modular master chip, and
wherein the modular master chip is capable of automatically regulating the modular master chip and each of the active slave chips at one or more interleaved clock speeds with one or more phase shifts to provide the scalable current to the current load.

16. The method as recited in claim 15, further comprising coupling one or more additional slave chips to the master modular chip to increase the maximum scalable current.

17. The method as recited in claim 15, further comprising decoupling one or more slave chips from the modular master chip to decrease the maximum scalable current.

18. A circuit, comprising:
a modular master chip, comprising:
an output module;
a phase control module in communication with the output module, the phase control module comprising a master chip switch, wherein the phase control module is adapted for regulating the master chip switch at one or more interleaved clock speeds with one or more phase shifts; and
a control module in communication with the output module and the phase control module, the control module being adapted for:
monitoring an amount of current drawn by a current load;
determining one or more interleaved clock speeds;
sending the one or more interleaved clock speeds; and
sending a scalable amount of current supplied to the current load by adjusting a number of output modules contributing to the scalable amount of current supplied to the current load.

19. The circuit as recited in claim 18, further comprising:
one or more slave chips, each slave chip comprising:
an output stage; and
a phase control stage in communication with the output stage, the phase control stage comprising a slave chip switch, wherein the phase control stage is adapted for regulating the slave chip switch at one or more interleaved clock speeds with one or more phase shifts,
wherein each of the one or more slave chips is coupled in parallel with the modular master chip, and
wherein the modular master chip is adapted for automatically regulating the modular master chip switch and each slave chip switch of the one or more slave chips at one or more interleaved clock speeds with one or more phase shifts to supply the scalable amount of current to the current load.

20. The circuit as recited in claim 19, further comprising an oscillator in communication with the phase control module and the phase control stage of each of the one or more slave chips, wherein the control circuit amplifier matches the oscillator for generating an oscillating signal.

21. The circuit as recited in claim 20, wherein the control circuit amplifier is adapted for sending a signal to distribute current contributions from each of the one or more slave chips and the modular master chip to contribute to the scalable amount of current supplied to the current load.

22. The circuit as recited in claim 20, wherein the phase control module and each phase control stage of the one or more slave chips comprise a real-time phase detector-splitter adapted for adjusting the one or more phase shifts at the one or more interleaved clock speeds in response to the signal from the control circuit amplifier.

23. The circuit as recited in claim 20, wherein the master witch and each slave switch of the one or more slave chips comprise a pulse-width modulator adapted for operating as a switch at one or more interleaved clock speeds with one or more phase shifts in response to the signal from the control circuit amplifier.

24. The circuit as recited in claim 19, wherein a loop couples the phase control module and each phase control stage in a closed circuit.

25. The circuit as recited in claim 18, wherein the control module is removably coupled to the phase control module.

26. The circuit as recited in claim 18, wherein the modular master chip comprises a control circuit amplifier.

27. The circuit as recited in claim 18, wherein the circuit is adapted for supplying the current load with an amount of current exceeding about 100 amperes at a corresponding potential of less than about 1 volt.

28. The circuit as recited in claim 18, wherein the output module comprises a driver, a voltage supply, one or more transistors, and a ground.

29. The circuit as recited in claim 18, wherein the one or more phase shifts are equally distributed across a band spectrum.

30. The circuit as recited in claim 18, wherein the control module and the phase control module are positioned at opposite sides of the master chip to maximize a useable pin count on the master chip.

31. The circuit as recited in claim 30, wherein the one or more slave chips are positioned between the control module and the phase control module, and wherein the one or more slave chips are adapted for direct access via removing the control module from the modular master chip.
